(19) United States
(12) Patent Application Publication
(10) Pub. No.: US 2014/0170403 A1
(43) Pub. Date: Jun. 19, 2014

(54) INORGANIC POLYMER MATERIAL, METHOD FOR FORMING THE SAME, AND INORGANIC POLYMER COATING PRODUCED THEREFROM

(71) Applicant: INDUSTRIAL TECHNOLOGY RESEARCH INSTITUTE, Hsinchu (TW)

(72) Inventors: Wei-Cheng TANG, Hsinchu City (TW); Yuung-Ching SHEEN, Hsinchu City (TW); Yuan-Chang HUANG, Hsinchu City (TW); Yi-Che SU, Zhubei City (TW); Yun-Shan HUANG, Zhunan Township (TW); Yih-Her CHANG, Baoshan Township (TW); Jen-Lien LIN, Hsinchu City (TW)

(73) Assignee: Industrial Technology Research Institute, Hsinchu (TW)

(21) Appl. No.: 13/890,993

(22) Filed: May 9, 2013

(30) Foreign Application Priority Data
Dec. 19, 2012 (TW) 101148232

(51) Int. Cl. C09D 183/02

(52) U.S. Cl. CPC C09D 183/02
USPC 428/220; 528/39; 528/12; 528/20; 524/588

(57) ABSTRACT

The present disclosure provides a method for forming an inorganic polymer material, including mixing 10 to 80 parts by weight of tetraalkoxysilane and 10 to 80 parts by weight of trialkoxysilane to form a mixture; and performing a reaction at pH of 0 to 4 by adding 5 to 30 parts by weight of a catalyst to the mixture to form an inorganic polymer material.

### CROSS REFERENCE TO RELATED APPLICATIONS

This application claims priority of Taiwan Patent Application No. 101148232, filed on Dec. 19, 2012, the entirety of which is incorporated by reference herein.

### TECHNICAL FIELD

The technical field relates to an inorganic polymer material and a method for forming the same, and in particular to an inorganic polymer material formed by polymerization.

### BACKGROUND

Nano-silicon dioxide formed by a sol-gel reaction has good heat resistance, weather resistance, and surface hardness, and has been widely used in various industries such as chemical engineering, precision casting, textiles, paper-making, electronics, and the like.

Generally, tetra-fuctional silane is used to form the silicon dioxide. However, the reaction tends to form nano clusters or spherical structures due to the high degree of crosslinking of the tetra-fuctional silane. Therefore, the solid content should not be too high (usually no more than 20%), or it may be gelling or precipitated. In addition, the film-forming ability of the sol-gel product is commonly poor, and thus the product may only be used as a thin coating (the thickness of the film may be between 100 and 500 nm). If the thickness of the film is required to be larger than about 5 μm, an organic polymer may be added to form an organic-inorganic hybrid material to improve its film-forming ability. However, if the organic material is used, the weather resistance and surface hardness of the resulting material may decrease.

### SUMMARY

An embodiment of the disclosure provides a method for forming an inorganic polymer material, including mixing 10 to 80 parts by weight of tetraalkoxysilane and 10 to 80 parts by weight of trialkoxysilane to form a mixture; performing a reaction at pH of 0 to 4 by adding 5 to 30 parts by weight of a catalyst to the mixture to form an inorganic polymer material.

Another embodiment of the disclosure provides an inorganic polymer coating formed by coating and curing the inorganic polymer material described previously, wherein the surface hardness of the inorganic polymer coating is at least 2H.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 illustrates a flow chart of a method for forming an inorganic polymer material.

FIG. 2a illustrates a reaction of a sol-gel reaction performed under a basic condition.

FIG. 2b illustrates a reaction of a sol-gel reaction performed under an acidic condition.

FIG. 3 illustrates an inorganic polymer coating according to one embodiment.

FIGS. 4a-4c illustrates reactions in which tetraalkoxysilane is solely used in the sot-gel reaction first, and then the product is modified by other organic functional groups according to some comparative embodiments.

FIG. 5 illustrates a reaction in which inorganic polymer material is heated directly to form an inorganic polymer coating, according to one embodiment.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

Moreover, the formation of a first feature over and on a second feature in the description that follows may include embodiments in which the first and second features are formed in direct contact, and may also include embodiments in which additional features may be formed between the first and second features, such that the first and second features may not be in direct contact.

According to one embodiment, a method for forming an inorganic polymer material is provided. According to the method, tetraalkoxysilane and trialkoxysilane are used to perform a sol-gel reaction at an acidic condition to form an inorganic polymer material, wherein the ratio between the tetraalkoxysilane and trialkoxysilane and the pH value of the reaction may be adjusted to control the resulting inorganic polymer material to have a desired linear portion and an appropriate degree of crosslinking. Thus, the resulting inorganic polymer material may have both the linear portion and the net portion in the structure.

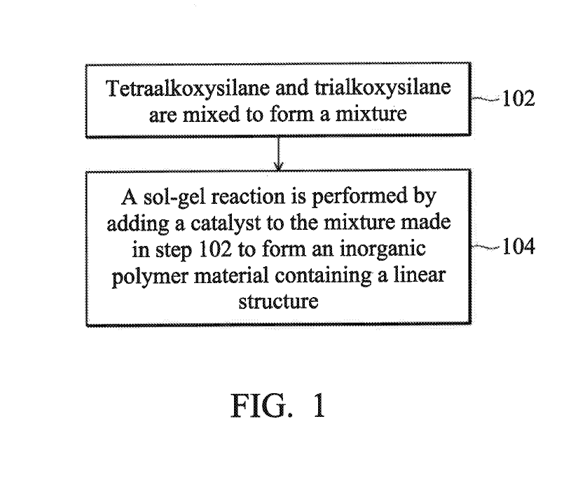

FIG. 1 illustrates a flow chart of a method for forming an inorganic polymer material. Referring to FIG. 1, in step 102, tetraalkoxysilane and trialkoxysilane are mixed to form a mixture. In step 104, a sol-gel reaction is performed by adding a catalyst to the mixture made in step 102 to form an inorganic polymer material containing a linear structure.

In the sol-gel reaction, the tetraalkoxysilane may have the following formula:

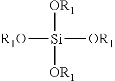

wherein R₁ is C₁ to C₈ linear alkyl group. In addition, the trialkoxysilane may have the following formula:

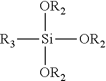

wherein R₂ is C₁ to C₅ linear alkyl group; R₃ is hydrogen, substituted or unsubstituted C₁ to C₈ alkyl group, substituted or unsubstituted C₁ to C₈ alkenyl group, epoxy group, or amino group. According to one embodiment, R₃ is substituted by fluorine. Table 1 and Table 2 show some possible examples of tetraalkoxysilane and trialkoxysilane. However, it is appreciated that these structures are merely examples and the scope of the invention is not intended to be limiting.

TABLE 1
Tetraalkoxysilane

| | |
|---|---|
| 1 | 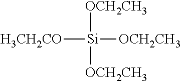 |
| 2 | 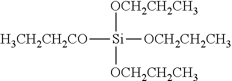 |
| 3 | 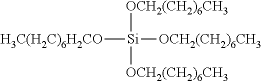 |
| 4 | 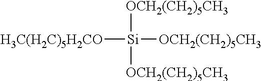 |
| 5 | 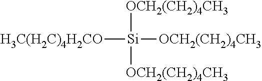 |

TABLE 2
Trialkoxysilane

| | |
|---|---|
| 6 | 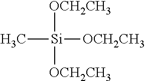 |
| 7 | 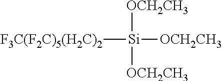 |
| 8 | 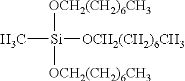 |
| 9 | 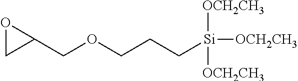 [SMILES: CCO[Si](CCCOCC1CO1)(OCC)OCC] |
| 10 | 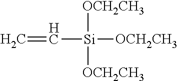 |

Examples of the catalyst used in the method illustrated in FIG. 1 may comprise, but are not limited to, hydrochloric acid, nitric acid, acetic acid, sulfuric acid, or a combination thereof. By using the catalyst, the reaction may be performed under an acidic condition with a pH value of between 0 and 4. According to one embodiment, the pH value of the sol-gel reaction is between 1 and 3.

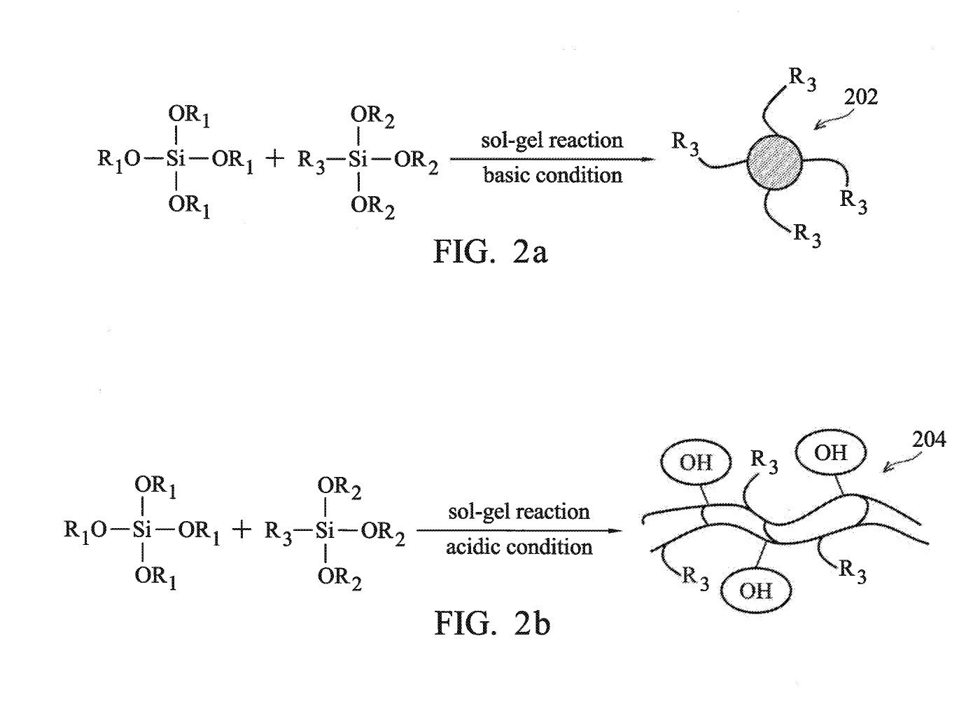

It should be noted that, if the sol-gel reaction is performed under a basic condition, the resulting product will have a spherical structure, as shown in FIG. 2a. In a sol-gel reaction, both polymerization and hydrolyzation occur. However, under a basic condition, the speed of polymerization becomes faster while the speed of hydrolyzation becomes slower. Thus, the reaction tends to form a core extending toward four dimensions, resulting in the spherical structure 202. When the spherical structure 202 is coated as a film, the film may have a greater thickness, but poor hardness, for being similar with a stacking of powders.

On the other hand, under an acidic condition, the speed of polymerization becomes slower while the speed of hydrolyzation becomes faster. Therefore, it tends to form a linear core first and then other structures may extend from the linear core. Thus, the structure 204 containing both a linear portion and a net portion can be formed, as shown in FIG. 2b. The resulting material may be formed as a coating, and the linear portion in the structure may prevent the coating from cracking, and the net portion in the structure may improve the density and the surface hardness. Therefore, the material may be widely used in various applications.

In addition, the weight ratio between each reactant in the sol-gel reaction may be adjusted as needed to form an inorganic polymer material with required properties. For example, in a sol-gel reaction, 10 to 80 parts by weight of tetraalkoxysilane, 10 to 80 parts by weight of trialkoxysilane; and 5 to 30 parts by weight of a catalyst may be used. According to another embodiment, 10 to 50 parts by weight of tetraalkoxysilane, 10 to 70 parts by weight of trialkoxysilane; and 5 to 15 parts by weight of a catalyst may be used. It is found that, the more the tetraalkoxysilane is used, the higher the crosslinking density of the inorganic polymer material is. In addition, as the use of the tetraalkoxysilane increases, the hardness of the coating also increases, but the coating also becomes fissile. Therefore, the use of the trialkoxysilane is needed to modify the material. However, if too much trialkoxysilane is used in the reaction, the crosslinking density of the inorganic polymer material may be too low, resulting in poor film strength and surface hardness, or insufficient weather resistance. Therefore, according to the required hardness of the material, the ratio between each reactant may be adjusted. Furthermore, the inorganic polymer material according to various embodiments may have a high inorganic content and good weather resistance.

According to another embodiment, 0.01 to 50 parts by weight of an organic solvent may be used in the sol-gel reaction. Examples of the organic solvent may include, but are not limited to, methanol, ethanol, isopropanol, butanol, sec-butyl alcohol, tert-butyl alcohol, or a combination thereof.

The inorganic content of the inorganic polymer material according to some embodiments may be at least 70% (TGA char yield). For example, the inorganic content of the inorganic polymer material according to some embodiments may be between 70 wt % and 95 wt % or between 80 wt % and 95 wt %. A weight average molecular weight of the inorganic polymer material may be at least 1000 g/mol. For example, a weight average molecular weight of the inorganic polymer material may be between about 1000 g/mol and 30000 g/mol according to one embodiment.

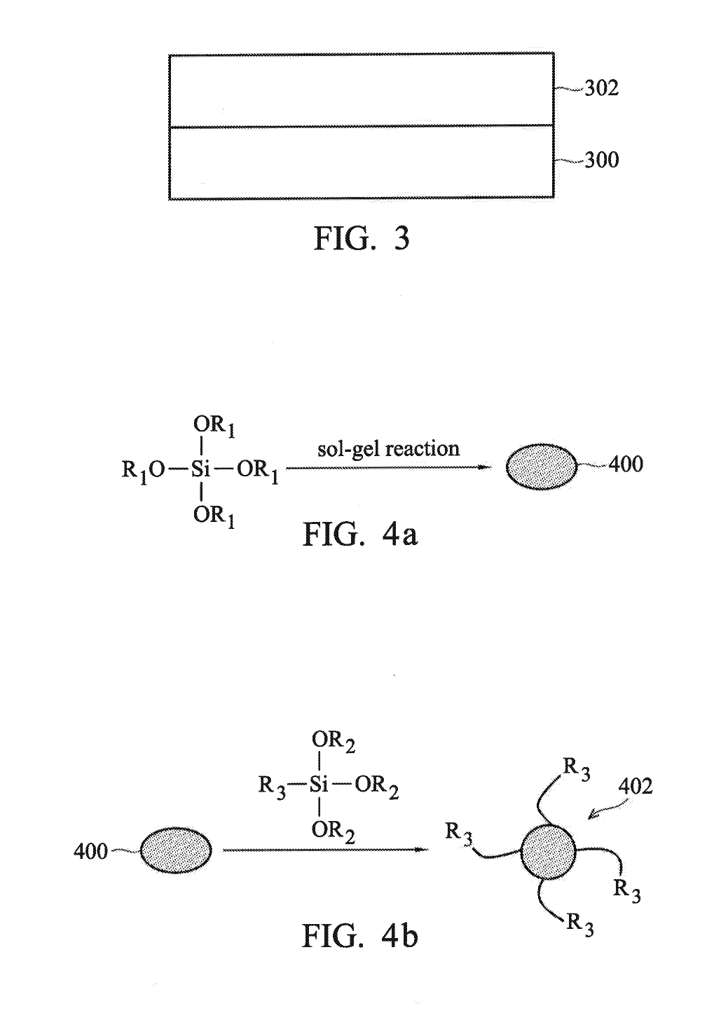

In addition, an inorganic polymer coating may be formed by coating and curing the inorganic polymer material, as shown in FIG. 3. FIG. 3 is a cross section of an inorganic polymer coating 320 on a substrate 300 formed by coating an inorganic polymer material onto the substrate 300. Methods for coating the inorganic polymer material onto the substrate 300 may include spray coating, spin coating, knife coating, dip coating, brush coating, or a combination thereof. Then, the inorganic polymer material may be cured to form an inorganic polymer coating 320 with a higher surface harness. The curing process may be performed at a temperature of below 160° C. For example, the temperature of the curing process may be between about 80° C. and 120° C. According to one embodiment, the surface hardness of the inorganic polymer coating is at least 2H. According to another embodiment, the surface hardness of the inorganic polymer coating is at least 4H. According to still another embodiment, the surface hardness of the inorganic polymer coating is between 2H and 9H, or between 3H and 9H.

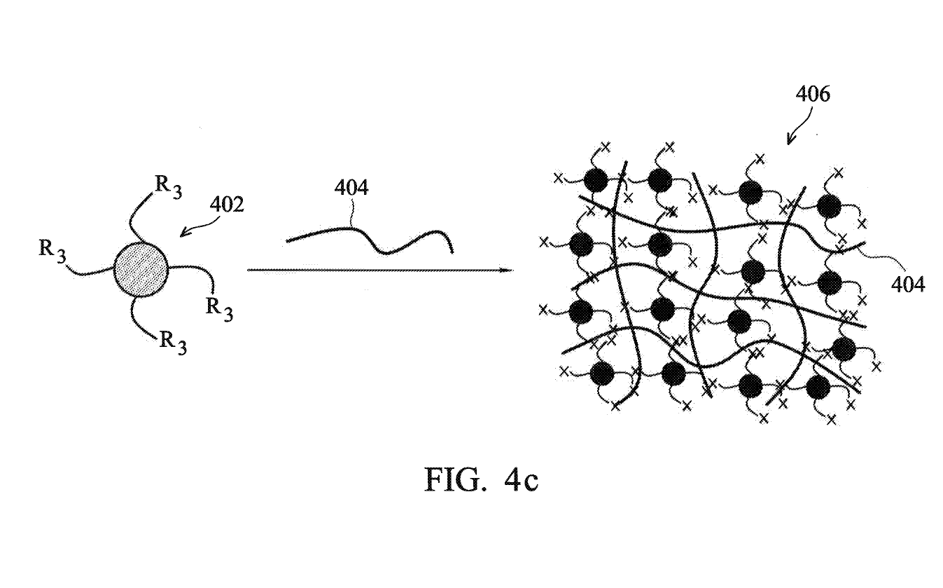

However, if the tetraalkoxysilane is solely used in the sol-gel reaction, the resulting nano-sol product 400 may have a spherical structure and be difficult to be formed as a film, as shown in FIG. 4a. In addition, even if the resulting nano-sol product 400 is modified by other organic functional groups (such as modified by trialkoxysilane), the nano-sol product 400 may be modified merely at the surface of the structure, as shown in FIG. 4b. Although the surface-modified nano-sol product 402 may be formed as a film, the thickness of the film is still limited. Furthermore, as shown in FIG. 4c, if an organic polymer is further added to the surface-modified nano-sol product 402, an organic-inorganic hybrid material 406 may be formed. However, although the film-forming ability of the organic-inorganic hybrid material 406 may be improved by adding the organic polymer, the inorganic content of the organic-inorganic hybrid material 406 is low and the weather resistance and surface hardness of the material are poor.

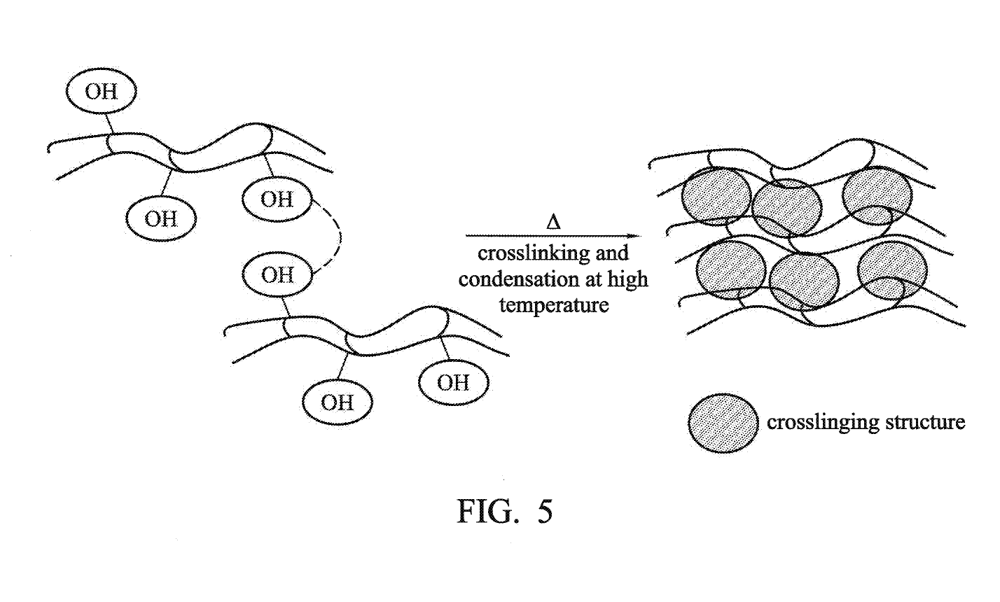

On the contrary, according to the embodiment shown in FIG. 3, the —OH groups of the inorganic polymers may perform the crosslinking reaction by heating (no need to add additional compounds, such as organic polymers) to cure and form a coating, as shown in FIG. 5. According to the embodiment, the thickness of the resulting inorganic polymer coating may be large (for example, the thickness of the coating may be at least 2 μm). In addition, the inorganic polymer coating may have good weather resistance (QUV>2000 hrs, or even QUV≧3000 hrs, according to Examples 6, 8, and 9, with testing by an Accelerated Weathering Tester), the desired hardness (for example, between 2H and 9H), and a good density. Therefore, the inorganic polymer coating may be widely used in various applications.

According to some embodiments, the weight ratio between the tetraalkoxysilane and the trialkoxysilane and the pH value of the sol-gel reaction may be adjusted to control the degree of crosslinking (the linear portion and the net portion) of the resulting inorganic polymer material, wherein the inorganic polymer material may have both a linear structure and a net structure, and the inorganic content of the inorganic polymer material may be high. In addition, an inorganic polymer coating formed of the inorganic polymer material may have improved hardness and weather resistance, and it may be able to be formed as a thicker coating.

### Examples 11

Tetraethyl orthosilicate (TEOS), methyltriethoxysilane (MTES), and 1H,1H,2H,2H-perfluorooctyl-triethoxysilane were mixed according to the ratio shown in Table 3. The mixture was stirred for ten minutes at room temperature, and isopropanol, water, and hydrochloric acid (0.1N) were added according to the ratio shown in Table 3. Then, a sol-gel reaction was performed for 16 hours at room temperature to form an inorganic polymer material. In addition, the resulting inorganic polymer materials in Examples 1-7 were further analyzed by gel permeation chromatography (GPC) to analyze the weight average molecular weight (Mw) of the inorganic polymer materials. A thermal gravimetric analysis (TGA) was used as increasing the temperature to 800° C. to analyze the inorganic content (char yield) of the inorganic polymer materials. In addition, the inorganic polymer materials were spray coated onto a galvanized iron sheet and dried for 30 minutes at 160° C. to form inorganic polymer coatings. The intensity (cross-cut test) and pencil hardness of the surface were tested according to Chinese National Standards CNS 10757, and the results are shown in Table 4.

As shown in Table 4, according to Examples 1-11, the resulting inorganic polymer materials can have various char yields and hardness by adjusting the ratio between tetraethyl orthosilicate, methyltriethoxysilane, and 1H,1H,2H,2H-perfluorooctyl-triethoxysilane and by adjusting the additional amount of the hydrochloric acid (i.e. for adjusting the pH value of the reaction). Therefore, the desired properties may be achieved by adjusting the ratio between the reactants.

### Comparative Example 1

Tetraethyl orthosilicate (TEOS), isopropanol, water, and hydrochloric acid (0.1N) were mixed according to the ratio shown in Table 3. Then, a sol-gel reaction was performed for 24 hours at room temperature. Next, 1H,1H,2H,2H-perfluorooctyl-triethoxysilane was added to the mixture and the reaction continued for 24 hours at room temperature to form a surface-modified nano-silica-sol product.

As shown in Table 4, the reaction in Comparative Example 1 was performed under an acidic condition with a large amount of organic solvent. The tetraethyl orthosilicate used in the sol-gel reaction tended to form nano-silica-sol product due to the low monomer concentration. The sol-gel product was then modified by 1H,1H,2H,2H-perfluorooctyl-triethoxysilane to form the surface-modified nano-silica-sol product. However, the surface-modified nano-silica-sol product could not be formed as a film.

### Comparative Example 2

Tetraethyl orthosilicate (TEOS), isopropanol, water, and 2-amino-2-methyl-1-propanol (AMP-95; organic base) were mixed according to the ratio shown in Table 3. Then, a sol-gel reaction was performed for 1 hour at room temperature. Next, 1H,1H,2H,2H-perfluorooctyl-triethoxysilane was added to the mixture and the reaction continued for 15 hours at room temperature to form a micro-powder material.

As shown in Table 4, the reaction in Comparative Example 2 was performed under basic condition and with a large amount of organic solvent. The sol-gel reaction was performed to the tetraethyl orthosilicate and the resulting product was then modified by 1H,1H,2H,2H-perfluorooctyl-triethoxysilane. However, the micro-powder material could not be formed as a film with good strength.

### Comparative Example 3

Methyltriethoxysilane, water, and hydrochloric acid (0.1N) were mixed according to the ratio shown in Table 3. Then, a sol-gel reaction was performed for 16 hours at room temperature to form an inorganic polymer material.

As shown in Table 4, the inorganic polymer material formed of methyltriethoxysilane in Comparative Example 3 had a high molecular weight. Although tetraethyl orthosilicate was not used in the reaction, the resulting product could still be formed as a film by physically crosslinking. However, the char yield of the material was low, and the weather resistance and hardness were poor.

### Comparative Example 4

Methyltriethoxysilane, isopropanol, water, and hydrochloric acid (0.1N) were mixed according to the ratio shown in Table 3. Then, a sol-gel reaction was performed for 16 hours at room temperature to form an inorganic polymer material.

As shown in Table 4, the sol-gel reaction in Comparative Example 4 was performed in organic solvent. Compared to Comparative Example 3, the inorganic polymer material in Comparative Example 4 had a lower molecular weight due to the insufficient physical crosslinking. The resulting film therefore had a citrus peel surface and the char yield of the material was low and the hardness was poor.

### Comparative Example 5

Tetraethyl orthosilicate (TEOS), isopropanol, water, and hydrochloric acid (0.1N) were mixed according to the ratio shown in Table 3. Then, a sol-gel reaction was performed for 16 hours at room temperature to form an inorganic polymer material.

As shown in Table 4, the reaction in Comparative Example 5 was performed in organic solvent to form the inorganic polymer material. However, the inorganic polymer material was fissile (showed cracking) and could not be formed as a smooth film due to the excess crosslinking density.

### Comparative Example 6

Tetraethyl orthosilicate (TEOS), water, and hydrochloric acid (0.1N) were mixed according to the ratio shown in Table 3. Then, a sot-gel reaction was performed for 16 hours at room temperature to form an inorganic polymer material.

As shown in Table 4, tetraethyl orthosilicate was used to form the inorganic polymer material. However, similar to Comparative Example 5, the inorganic polymer material was fissile and could not be formed as a smooth film.

### Comparative Example 7

Tetraethyl orthosilicate (TEOS) and methyltriethoxysilane (MTES) were mixed according to the ratio shown in Table 3. The mixture was stirred for ten minutes at room temperature, and isopropanol, water, and 2-amino-2-methyl-1-propanol (AMP-95 organic base) were added in a ratio as shown in Table 3. Then, a sol-gel reaction was performed for 7 hours at room temperature to form a micro-powder material.

As shown in Table 4, although both tetraethyl orthosilicate and methyltriethoxysilane were used in the sol-gel reaction, the micro-powder material was formed resulting from the basic condition. In addition, the micro-powder material could not be formed as a film.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

TABLE 3

| | | | 1H,1H,2H,2H- | | | | |
|---|---|---|---|---|---|---|---|
| | | | perfluorooctyl- | | | Hydrochloric | |
| | TEOS | MTES | triethoxysilane | Isopropanol | DI water | acid (0.1N) | AMP-95 |
| | (wt %) | (wt %) | (wt %) | (wt %) | (wt %) | (wt %) | (wt %) |
| Example 1 | 42.85 | 14.29 | — | 28.57 | 6.63 | 7.66 | — |
| Example 2 | 28.57 | 28.57 | — | 28.57 | 6.63 | 7.66 | — |
| Example 3 | 14.29 | 42.85 | — | 28.57 | 6.63 | 7.66 | — |
| Example 4 | 60 | 20 | — | — | 9.27 | 10.72 | — |
| Example 5 | 40 | 40 | — | — | 9.27 | 10.72 | — |
| Example 6 | 20 | 60 | — | — | 9.27 | 10.72 | — |
| Example 7 | 20 | 50 | 10 | — | 9.27 | 10.72 | — |
| Example 8 | 30 | 50 | — | — | 9.27 | 10.72 | — |
| Example 9 | 25 | 55 | — | — | 9.27 | 10.72 | — |
| Example 10 | 15 | 65 | — | — | 9.27 | 10.72 | — |
| Example 11 | 10 | 70 | — | — | 9.27 | 10.72 | — |
| Comparative | 15.07 | — | 15.07 | 58.61 | 5.22 | 6.03 | — |
| Example 1 | | | | | | | |
| Comparative | 7.55 | 7.55 | 2.26 | 77.43 | 1.81 | — | 3.4 |
| Example 2 | | | | | | | |
| Comparative | — | 80 | — | — | — | 20 | — |
| Example 3 | | | | | | | |
| Comparative | — | 57.14 | — | 28.57 | — | 14.29 | — |
| Example 4 | | | | | | | |
| Comparative | 57.14 | — | — | 28.57 | — | 14.29 | — |
| Example 5 | | | | | | | |
| Comparative | 80 | — | — | — | — | 20 | — |
| Example 6 | | | | | | | |
| Comparative | 8.9 | 4.56 | — | 74.75 | 3.74 | — | 8.05 |
| Example 7 | | | | | | | |

TABLE 4

| | | Char | Molecular | | | | | |
|---|---|---|---|---|---|---|---|---|
| | pH | yield | weight | Film | Thickness | | Bend for | Pencil |
| | value | (%) | (Mw) | formation | (μm) | Intensity | 2 mm | hardness |
| Example 1 | 1.73 | 80.94 | 1513 | ◯ | 4.8 | 100/100 | ◯ | 8H |
| | | | | | | | (Bendable) | |
| Example 2 | 1.79 | 83.78 | 1498 | ◯ | 6.2 | 100/100 | ◯ | 8H |
| Example 3 | 1.89 | 88.19 | 1456 | ◯ | 5.6 | 100/100 | ◯ | 8H |
| Example 4 | 1.68 | 81.69 | 3475 | ◯ | 4 | 100/100 | ◯ | 9H |
| Example 5 | 1.77 | 84.81 | 3509 | ◯ | 6.8 | 100/100 | ◯ | 8H |
| Example 6 | 1.85 | 89.82 | 3435 | ◯ | 5.6 | 100/100 | ◯ | 4H |
| Example 7 | 2.13 | 70.25 | 26090 | ◯ | 6.3 | 100/100 | ◯ | 6H |
| Example 8 | 1.76 | 89.82 | — | ◯ | 6.1 | 100/100 | ◯ | 7H |
| Example 9 | 1.85 | 89.48 | — | ◯ | 7.2 | 100/100 | ◯ | 7H |
| Example 10 | 1.82 | 90.74 | — | ◯ | 8 | 100/100 | ◯ | 4H |
| Example 11 | 1.79 | 91.89 | — | ◯ | 6.2 | 100/100 | ◯ | 2H |
| Comparative | 2.85 | — | — | powder | — | — | — | — |
| Example 1 | | | | | | | | |
| Comparative | 10.83 | — | — | powder | — | — | — | — |
| Example 2 | | | | | | | | |
| Comparative | 1.91 | 59.79 | 3113 | ◯ | 5.4 | 100/100 | ◯ | H |
| Example 3 | | | | | | | | |
| Comparative | 1.94 | 29.77 | 1428 | orange | 4.8 | 100/100 | ◯ | 2B |
| Example 4 | | | | peel effect | | | | |
| Comparative | 1.80 | 80.57 | 1500 | cracking | 5 | — | — | — |
| Example 5 | | | | | | | | |
| Comparative | 1.58 | 80.01 | 2448 | cracking | 5.4 | — | — | — |
| Example 6 | | | | | | | | |
| Comparative | 10.55 | — | — | powder | — | — | — | — |
| Example 7 | | | | | | | | |

1. A method for forming an inorganic polymer material, comprising;
mixing 10 to 80 parts by weight of tetraalkoxysilane and 10 to 80 parts by weight of trialkoxysilane to form a mixture; and
performing a reaction at pH of 0 to 4 by adding 5 to 30 parts by weight of a catalyst to the mixture to form an inorganic polymer material.

2. The method for forming an inorganic polymer material as claimed in claim 1, wherein the tetraalkoxysilane has the following formula: 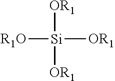
wherein R₁ is C₁ to C₈ linear alkyl group.

3. The method for forming an inorganic polymer material as claimed in claim 1, wherein the trialkoxysilane has the following formula: 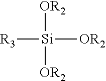
wherein R₂ is C₁ to C₈ linear alkyl group; R₃ is hydrogen, substituted or unsubstituted C₁ to C₈ alkyl group, substituted or unsubstituted C₁ to C₈ alkenyl group, epoxy group, or amino group.

4. The method for forming an inorganic polymer material as claimed in claim 3, wherein R₃ is a functional group containing a fluorine substitution.

5. The method for forming an inorganic polymer material as claimed in claim 1, wherein the catalyst comprises hydrochloric acid, nitric acid, acetic acid, sulfuric acid, or a combination thereof.

6. The method for forming an inorganic polymer material as claimed in claim 1, further comprising using an organic solvent.

7. The method for forming an inorganic polymer material as claimed in claim 6, wherein the organic solvent comprises methanol, ethanol, isopropanol, butanol, sec-butyl alcohol, tert-butyl alcohol, or a combination thereof.

8. The method for forming an inorganic polymer material as claimed in claim 6, wherein 0.01 to 50 parts by weight of the organic solvent is used.

9. An inorganic polymer material formed by the method as claimed in claim 1, wherein an inorganic content of the inorganic polymer material is at least 70%.

10. The inorganic polymer material as claimed in claim 9, wherein a weight average molecular weight of the inorganic polymer material is at least 1000 g/mol.

11. An inorganic polymer coating formed by coating and curing the inorganic polymer material as claimed in claim 9, wherein the surface hardness of the inorganic polymer coating is at least 2H.

12. The inorganic polymer coating as claimed in claim 11, wherein the thickness of the inorganic polymer coating is at least 2 μm.
